(19) United States
(12) Patent Application Publication
(10) Pub. No.: US 2006/0278172 A1
(43) Pub. Date: Dec. 14, 2006

(54) Interactive bird perches

(76) Inventors: Peter Ragonetti, Brooklyn, NY (US); Jonathan Willinger, Tenafly, NJ (US)

Correspondence Address: KATTEN MUCHIN ROSENMAN LLP, 575 MADISON AVENUE, NEW YORK, NY, 10022-2585, US

(21) Appl. No.: 11/446,577

(22) Filed: Jun. 2, 2006

Related U.S. Application Data
(63) Continuation-in-part of application No. 10/770,987, filed on Feb. 3, 2004, now Pat. No. 7,111,583.
Application No. 10/770,987 is a continuation-in-part of application No. 10/365,360, filed on Feb. 12, 2003, now Pat. No. 6,684,818.
(60) Provisional application No. 60/686,783, filed on Jun. 2, 2005.
(60) Provisional application No. 60/370,200, filed on Apr. 5, 2002.

(51) Int. Cl. A01K 31/12

(52) U.S. Cl. 119/468

(57) ABSTRACT

A bird perch unit is configured with a body coupleable to a bird cage and having an outer surface which is grippeable by a bird, and an interactive toy coupled to the body and alterable by the bird.

### CROSS-REFERENCE TO RELATED APPLICATIONS

This application is a non-provisional counterpart to and claims priority to Provisional Patent Application 60/686,783 filed on Jun. 2, 2005, and which is pending; This application is a continuation-in-part of U.S. application Ser. No. 10/770,987, filed Feb. 3, 2004 entitled “Birdcage Perch, ” and which is pending and which is a continuation-in-part of U.S. application Ser. No. 10/365,360, filed Feb. 12, 2003 also entitled “Birdcage Perch”, and issued Feb. 3, 2004 as U.S. Pat. No. 6,684,818 which claimed the benefit under 35 U.S.C. Section 119(e) from U.S. Provisional Application 60/370,200, filed Apr. 5, 2002. All of the above applications and patent are hereby incorporated by reference for all purposes.

### BACKGROUND OF THE INVENTION

1. Field of the Invention

The present invention relates generally to birdcage perches, and more particularly to lightweight, inexpensive perches that are interactive and entertaining for pet birds.

2. Discussion of the Prior Art

An important part of caged bird-keeping is the use of perches for pet birds to stand on. The perches simulate the branches of trees that birds stand on in the wild. There are many types of perches that have been produced in the past. These have included wooden dowels of varying lengths, actual tree branches, extruded plastic rods and injection molded plastic pieces.

There are problems with each of these prior products. The wooden dowels have little texture, which is not conducive to keeping the bird's claws healthy. The tree branches can deteriorate and are expensive to make ready for attachment to the cage. The plastic rods and molded pieces typically do not have a rough enough or deep enough texture to exercise the toes of the bird's feet. Injection molded perches are typically open on the bottom, thereby having a large open gap such that the end of the claws does not press against anything in use. Extruded rods cannot be varied in diameter, thereby leading to a lack of stimulation of the feet and claws. Further, the vast majority of such perches do not provide any kind of interactive features as part of the perch and thus, do not provide anything more than an inferior place to perch.

Most of the birds kept as pets and sold in the pet trade as companion birds belong to the Psittacine family of birds. The family includes the most popular bird, the parakeet, also called budgerigar or simply budgie, as well as lovebirds, cockatiels and parrots. These birds are highly inquisitive, agile, manipulative and easily trained. Being confined in cages, they are often perceived as suffering from boredom unless provided with some objects that arouse their interest. It has been observed that pet birds that are not stimulated do not live as long as those that are.

Many so-called toys are being sold to keep these birds busy, but few of the toys seem to offer any real challenge to the bird's natural curiosity. Most toys are made for either chewing or climbing—certainly activities, which these birds should engage in—but are not necessarily challenging to the bird's inquisitive mind.

Accordingly, a need exists for interactive toys that offer pet birds an engaging experience, present the pet birds with a new experience over conventional toys, and challenge pet birds ' natural curiosity.

### SUMMARY OF THE INVENTION

An interactive perch is formed from plastic, wood or the like and includes one or more integrated interactive toys that may be moved, turned, pulled, rung, spun, pushed, clawed, activated, or otherwise altered by a pet bird on or near the perch. The inventive interactive perch provides a pet bird with an inexpensive, suitable perch as well as stimulation and challenging activities such as, for example, bell ringing, rope pulling, and shape spinning. In some embodiments, different toys may be replaceable and/or substitutable for each other such that the perch is configurable by the pet caretaker. In some embodiments, interaction with one toy mounted on the perch may cause movement or activation of a second toy mounted on the perch.

### BRIEF DESCRIPTION OF THE DRAWINGS

FIG. 1 is a perspective view illustrating a first example embodiment of an interactive perch according to the invention.

FIG. 2 is a perspective view illustrating a second example embodiment of an interactive perch according to the invention.

FIG. 3 is a perspective view illustrating a third example embodiment of an interactive perch according to the invention.

FIG. 4 is a perspective view illustrating a fourth example embodiment of an interactive perch according to the invention.

FIG. 5 is a perspective view illustrating a fifth example embodiment of an interactive perch according to the invention.

FIG. 6 is a perspective view illustrating a sixth example embodiment of an interactive perch according to the invention.

FIG. 7 is a perspective view illustrating a seventh example embodiment of an interactive perch according to the invention.

FIG. 8 is a perspective view illustrating a eighth example embodiment of an interactive perch according to the invention.

FIG. 9 is a perspective view illustrating a ninth example embodiment of an interactive perch according to the invention.

FIG. 10 is a perspective view illustrating a tenth example embodiment of an interactive perch according to the invention.

FIG. 11 is a perspective view illustrating a eleventh example embodiment of an interactive perch according to the invention.

FIG. 12 is a perspective view illustrating a twelfth example embodiment of an interactive perch according to the invention.

FIG. 13 is a diagrammatic view of an interactive perch according to the invention illustrating an embodiment of the invention that has multiple perches with respective toys that interact with one another.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect, ” “couple, ” and similar terms with their inflectional morphemes do not necessarily denote direct and immediate connections, but also include connections through mediate elements or devices. Furthermore, such terms as “perch, ” “interactive perch, ” “bird perch, ” and “birdcage perch” are used interchangeably.

It should be understood that the following detailed description is of the best mode or modes of the invention presently contemplated. Such description is not intended to be understood in a limiting sense, but to be examples of the invention presented solely for illustration thereof, and by reference to which in connection with the following description and the accompanying drawings one skilled in the art may be advised of the advantages and construction of the invention.

Within the meaning of this application, “integral” shall mean any type of connection having any number of connecting parts in permanent or temporary engagement.

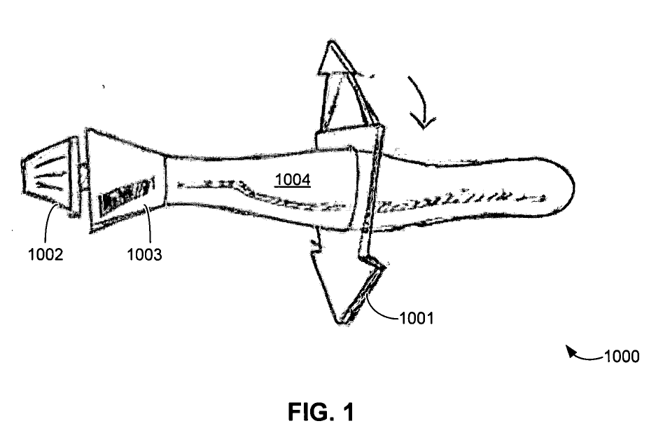

Turning to FIG. 1, a perspective view is provided that illustrates an example embodiment of an interactive perch 1000 including a spinning arrow toy 1001. The perch 1000 includes a retaining nut 1002, a base 1003, and an outer gripping surface 1004. The retaining nut 1002 may screw onto the base 1003 so that the perch 1000 may be mounted between the bars of a birdcage. The outer gripping surface 1004 is coupled to the base 1003 in the example embodiment depicted. In some embodiments, the example perch 1000 may be hollow and formed by joining two halves via any practicable means. Examples of details of bird perches that may be modified to be interactive according to the various embodiments of the present invention may be found in previously incorporated U.S. patent application Ser. No. 10/770,987 and previously incorporated U.S. Pat. No. 6,684,818.

The example spinning arrow toy 1001 of FIG. 1 includes two differently sized arrow shapes that are pointing in opposite directions and are joined together at each of the bases of the two arrows. The larger of the two arrows includes a hole through which the perch 1000 protrudes and about which the spinning arrow toy 1001 rotates. In some embodiments, the arrows may be of equal size. In some embodiments, differently sized arrows may be made from different density or thickness materials so that the weight of the arrows match sufficiently to balance the spinning arrow toy 1001 on the perch 1000.

Although arrow shapes are depicted FIG. 1, in other embodiments, any shapes, including for example, squares, triangles, polygons, bird profile shapes, irregular shapes, etc., may be used. The shapes may be mounted on the perch 1000 via a collar (not shown) or bearing that permits the shapes to be spun freely in either direction by a pet bird. In some embodiments, the shapes may be removable by a pet owner. Likewise, the collar may be removable and/or adjustable so that the pet owner or manufacturer may locate the toy at any point on the perch 1000. In some embodiments, a kit sold with the perch 1000 may include any number of interchangeable shapes that may be mounted on the collar by a pet owner. The shapes may be any color, they may be transparent, and they may be made from any suitable or practicable material such as plastic, wood, and/or edible material. The shapes may come in different sizes and thicknesses suitable for different size pet birds. In some embodiments, the ease with which the shapes turn may be adjustable by adjusting the collar to provide the pet bird with more variety. Any number of spinning shape toys may be mounted on a perch 1000. In some embodiments, the shapes may include a projection (not shown) that extends from the shape and can push or activate an adjacently mounted toy, e.g., spin a second spinning toy or ring a toy bell. In some embodiments, two spinning shape toys may be linked via a hidden axel within the perch 1000 such that turning one shape toy causes the second shape to turn. In yet other embodiments, a sound generator (e.g., mechanical or electronic) may be activated by turning a spinning shape toy. The sound generator may be mounted within the perch.

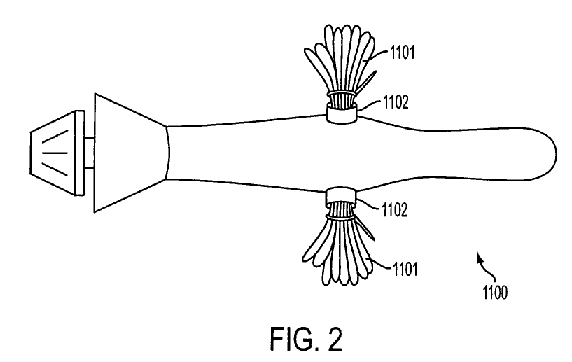

Turning to FIG. 2, a perspective view is provided that illustrates an example embodiment of an interactive perch 1100 including two bristle toys 1101. Any number of bristle toys 1101 may be mounted anywhere on the perch 1100. The bristles may be made from any material that is suitable and safe for a bird to play with. The bristles may be soft and flexible like hair or feathers. In some embodiments, the bristles may be stiff like brush quills. In some embodiments, a collar 1102 that mounts to the perch or extends through the perch and includes bristles protruding from either end of the collar 1102 may bind the bristles together. In some embodiments, the bristles may mount to a spinning collar that allows the pet bird to move the bristles around the perch 1100. Any number, length, or color of bristles may be employed.

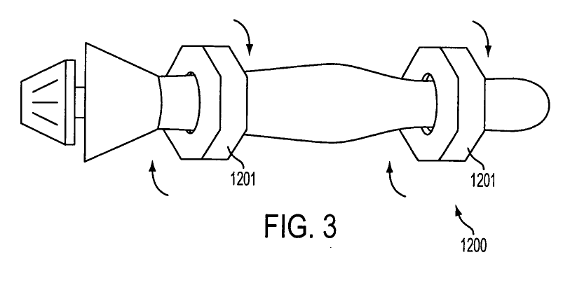

Turning to FIG. 3, a perspective view is provided that illustrates an example embodiment of an interactive perch 1200 including two spinning nut toys 1201. As with the spinning shape toy of FIG. 1, any number of nut toys 1201 may be mounted on the interactive bird perch 1200 of the present invention. The nut shapes may include hex nut shapes, octagon nut shapes, etc. and may be mounted on the perch 1200 via a collar (not shown) or bearing that permits the nut shapes to be spun freely in either direction by a pet bird. In some embodiments, the nut shapes may be removable by a pet owner. Likewise, the collar may be removable and/or adjustable so that the pet owner or manufacturer may locate the nut shape at any point on the perch 1200. In some embodiments, a kit sold with the perch 1200 may include any number of interchangeable nut shapes that may be mounted on the collar by a pet owner. The nut shapes may be any color, they may be transparent, and they may be made from any suitable or practicable material such as plastic, wood, and/or edible material. The nut shapes may come in different sizes and thicknesses suitable for different size pet birds. In some embodiments, the ease with which the nut shapes turn may be adjustable by adjusting the collar to provide the pet bird with more variety. In some embodiments, the nut shapes may include a projection that extends from the shape and can push or activate an adjacently mounted toy, e.g., spin second spinning toy or ring a toy bell. In some embodiments, two nut shapes may be linked via a hidden axel within the perch such that turning one nut shape causes the second nut shape to spin. In yet other embodiments, a sound generator (e.g., mechanical or electronic) may be activated by turning a spinning nut shape toy 1201. The sound generator may be mounted within the perch 1200.

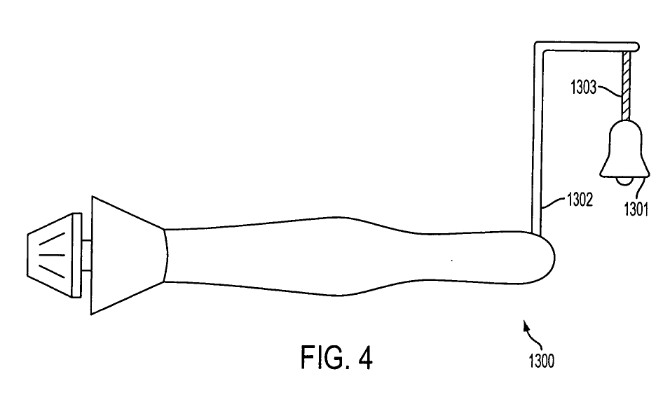

Turning to FIG. 4, a perspective view is provided that illustrates an example embodiment of an interactive perch 1300 including a toy bell 1301 suspended from an armature 1302 off the tip of the bird perch. The toy bell 1301 may be any style of bell. The toy bell's armature 1302 may be L-shaped and mounted anywhere along the perch 1300 such that a bird on the perch must stretch to ring the bell 1301. The bell 1301 may be suspended from the armature 1302 via a rope 1303 or chain or any suitable means including an elastic strap that can stretch in response to the pet bird pulling on the toy. In some embodiments, other toys, including any number of different shapes and interactive electronic/mechanical devices, may be suspended from the armature 1302. For example, a pull string device that plays a recording of the pet owner's voice may be suspended from the armature 1302.

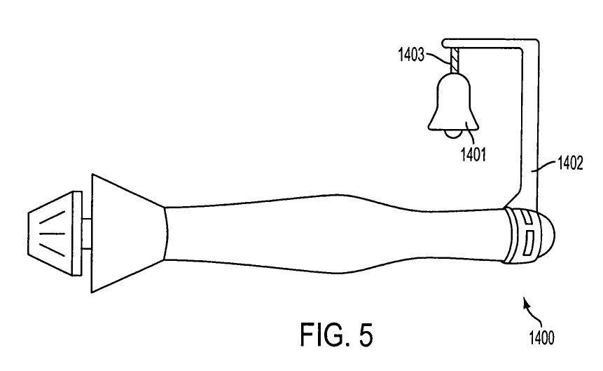

Turning to FIG. 5, a perspective view is provided that illustrates an example embodiment of an interactive perch 1400 including a toy bell 1401 suspended from an armature 1402 above the bird perch 1400. The toy bell 1401 may be any style of bell. The toy bell's armature 1402 may be L-shaped and mounted anywhere along the perch 1400 such that a bird on the perch 1400 does not need to stretch to ring the bell 1401. The bell 1401 may be suspended from the armature 1402 via a rope 1403 or chain or any suitable means including an elastic strap that can stretch in response to the pet bird pulling on the toy. In some embodiments, other toys, including any number of different shapes and interactive electronic/mechanical devices, may be suspended from the armature 1402. For example, a pull string device that plays a recording of the pet owner's voice may be suspended from the armature 1402.

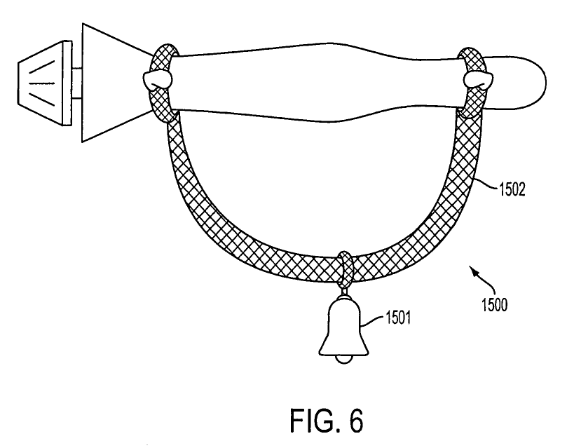

Turning to FIG. 6, a perspective view is provided that illustrates an example embodiment of an interactive perch 1500 including a toy bell 1501 suspended from a loop 1502 of rope or chain whose ends are both attached to the perch 1500 at different points. The loop 1502 may mounted anywhere along the perch 1500. The toy bell 1501 may be any style of bell. The bell 1501 may be suspended from a rope or chain or any suitable means including an elastic strap that can stretch in response to the pet bird pulling on the toy. In some embodiments, other toys, including any number of different shapes and interactive electronic/mechanical devices, may be suspended from the loop 1502. For example, a pull string device that plays a recording of the pet owner's voice may be suspended from the loop 1502.

In some alternative embodiments, the loop 1502 may extend through two holes in the perch 1500 instead of being fixedly attached to the perch 1500 as depicted in FIG. 6. In other words, a bird on such an alternative perch 1500 would be able to pull an end of the loop 1502 up through one of the holes to ring the bell 1501. Knots at either end of the loop 1502 may be used to prevent the loop 1502 from being pulled all the way through the holes. The weight of the bell 1501 may tend to pull the loop 1502 downward so that the loop 1502 rests on the knots.

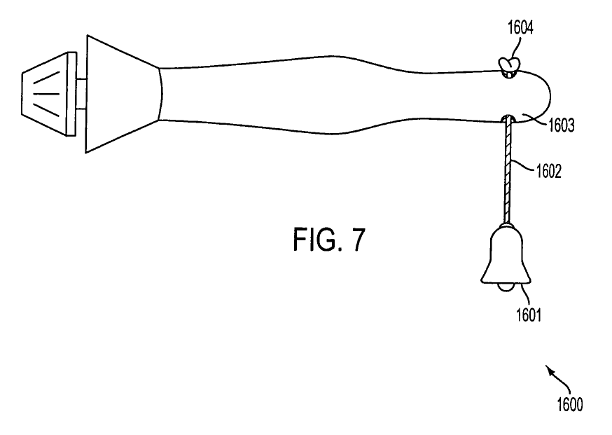

Turning to FIG. 7, a perspective view is provided that illustrates an example embodiment of an interactive perch 1600 including a toy bell 1601 suspended from the end of a length of rope 1602 or chain with the other end threaded through a hole 1603 in the perch 1600. The length of rope 1602 may be threaded through a hole 1603 located at any point along the perch 1600 and adapted to allow a pet bird to pull the length of rope 1602 through the hole 1603 in the perch 1600. The hole 1603 may be disposed vertically (as depicted), horizontally, or diagonally through the perch 1600. The toy bell 1601 may be any style of bell. The bell 1601 may be suspended from a rope 1602 or chain or any suitable means including an elastic strap that can stretch in response to the pet bird pulling on the toy. The rope 1602 may have a varied thickness along its length to provided a varied amount of resistance as the rope is pulled through the hole 1603 by a pet bird. In some embodiments, other toys, including any number of different shapes and interactive electronic/mechanical devices, may be suspended from the length of rope 1602. For example, a pull string device that plays a recording of the pet owner's voice may be suspended from the length of rope 1602. The rope may include a knot 1604 at the end opposite the toy to prevent the rope 1602 from slipping all the way through the hole 1603 in the perch 1600.

It should be appreciated that hole 1603 or 1802 (described below) may be used to attach a horizontal member to the perch and then extends to the birdcage. Such a horizontal member may be used for support of the perch or as an additional perch or perch-like structure for a pet bird.

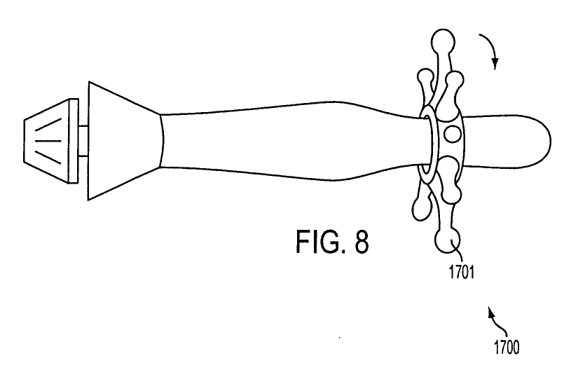

Turning to FIG. 8, a perspective view is provided that illustrates an example embodiment of an interactive perch 1700 including a spinning, nautical-style, pilot's ship wheel toy 1101. As with the spinning shape toy of FIG. 1, any number of ship wheel toys 1700 may be mounted on the interactive bird perch 1700 of the present invention. The ship wheel shapes may be mounted on the perch 1700 via a collar (not shown) or bearing that permits the ship wheel shapes to be spun freely in either direction by a pet bird. In some embodiments, the ship wheel shapes may be removable by a pet owner. Likewise, the collar may be removable and/or adjustable so that the pet owner or manufacturer may locate the ship wheel shape at any point on the perch 1700. In some embodiments, a kit sold with the perch 1700 may include any number of interchangeable ship wheel shapes that may be mounted on the collar by a pet owner. The ship wheel shapes may be any color, they may be transparent, and they may be made from any suitable or practicable material such as plastic, wood, and/or edible material. The ship wheel shapes may come in different sizes and thicknesses suitable for different size pet birds. In some embodiments, the ease with which the ship wheel shapes turn may be adjustable by adjusting the collar to provide the pet bird with more variety. In some embodiments, the ship wheel shapes may include a projection that extends from the shape and can push or activate an adjacently mounted toy, e.g., spin a second spinning toy or ring a toy bell. In some embodiments, two ship wheel shapes may be linked via a hidden axel within the perch 1700 such that turning one ship wheel shape causes the second ship wheel shape to spin. In yet other embodiments, a sound generator (e.g., mechanical or electronic) may be activated by turning a spinning ship wheel shape toy 1701. The sound generator may be mounted within the perch.

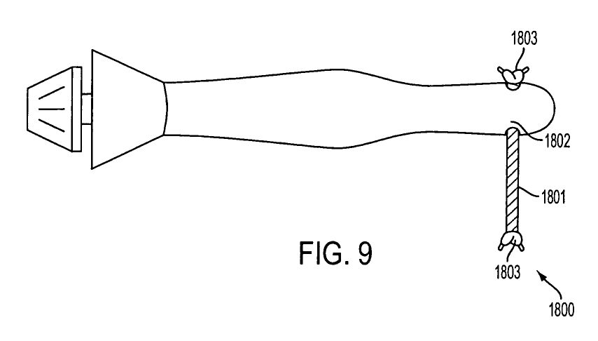

Turning to FIG. 9, a perspective view is provided that illustrates an example embodiment of an interactive perch 1800 including a length of rope 1801, chain, or other narrow item, threaded through a hole 1802 in the perch 1800. The length of rope 1801 may be threaded through a hole 1802 at any point along the perch 1800 and may be adapted to allow a pet bird to pull the length of the rope 1801 through hole 1802 in the perch 1800. The rope 1801 or chain may be made of any suitable material including an elastic strap that can stretch in response to the pet bird pulling on the strap. The rope 1801 may include knots 1803 at the ends to prevent the rope 1801 from slipping all the way through the hole 1802 in the perch 1800.

In some alternative embodiments, a length of rope may extend through a platform (not shown) or floor and be likewise adapted to allow a pet bird to push and pull the rope through the platform. In such embodiments, the platform may mount to the side of the birdcage in a manner similar to the perch or be suspended from the roof of the birdcage. In some other embodiments the platform may be moveably mounted to the roof or wall of the cage, and by pulling on the rope, the bird may move the platform. In some embodiments, a rod, a linked rod, a rod and rope combination, and/or other long narrow device may by used in place of the rope 1801.

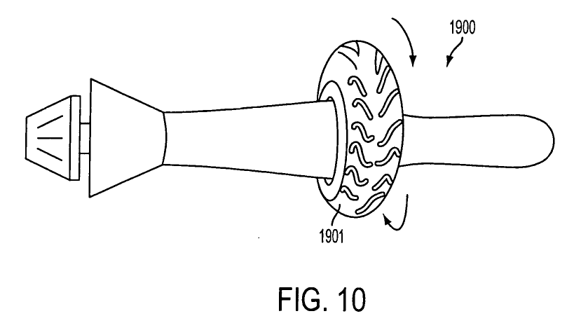

Turning to FIG. 10, a perspective view is provided that illustrates an example embodiment of an interactive perch 1900 including a spinning tire toy 1901. As with the spinning shape toy of FIG. 1, any number of tire toys 1901 may be mounted on the interactive bird perch 1900 of the present invention. The tire shapes may be mounted on the perch 1900 via a collar (not shown) or bearing that permits the tire shapes to be spun freely in either direction by a pet bird. In some embodiments, the tire shapes may be removable by a pet owner. Likewise, the collar may be removable and/or adjustable so that the pet owner or manufacturer may locate the tire shape at any point on the perch 1900. In some embodiments, a kit sold with the perch 1900 may include any number of interchangeable tire shapes that may be mounted on the collar by a pet owner. The tire shapes may be any color, they may be transparent, and they may be made from any suitable or practicable material such as plastic, wood, and/or edible material. The tire shapes may come in different sizes and thicknesses suitable for different size pet birds. In some embodiments, the ease with which the tire shapes turn may be adjustable by adjusting the collar to provide the pet bird with more variety. The tire shapes may include any pattern of treads or texturing. In some embodiments, the tire shapes may include a projection that extends from the shape and can push or activate an adjacently mounted toy, e.g., spin a second spinning toy or ring a toy bell. In some embodiments, two tire shapes may be linked via a hidden axel within the perch such that turning one tire shape causes the second tire shape to spin. In yet other embodiments, a sound generator (e.g., mechanical or electronic) may be activated by turning a spinning tire shape toy 1901. The sound generator may be mounted within the perch.

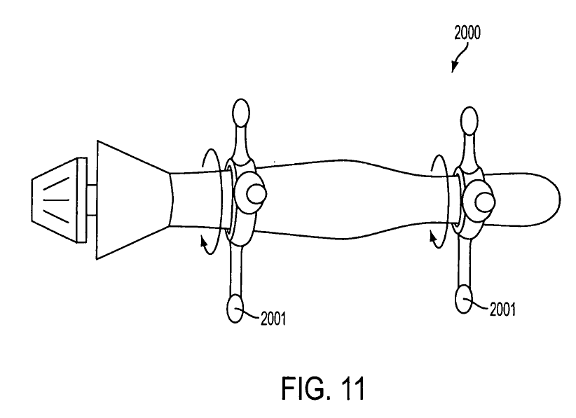

Turning to FIG. 11, a perspective view is provided that illustrates an example embodiment of an interactive perch 2000 including two spinning, nautical-style, pilot's ship wheel toys 2001 mounted at either end of the perch. Note that the spinning, nautical-style, pilot's ship wheel toys 2001 of FIG. 11 represents an alternative embodiment of the spinning, nautical-style, pilot's ship wheel toy 1101 of FIG. 8. However, the operational features and possible variations described above with respect to FIG. 8 are applicable to the example perch 2000 embodiment of FIG. 11.

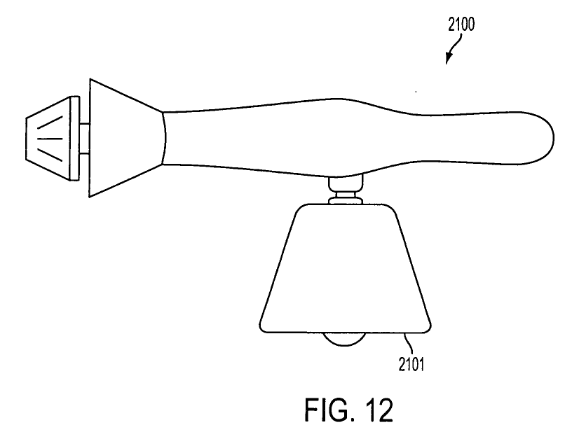

Turning to FIG. 12, a perspective view is provided that illustrates an example embodiment of an interactive perch 2100 including a toy cow bell 2101 suspended from the bottom of the perch 2100. The toy bell 2101 may be mounted anywhere along the perch 2100. In particular, the toy bell 2101 may be mounted toward the unsupported end of the perch 2100 so that the bird may cause the bell 2101 to ring by landing on, jumping from, and/or bouncing on the perch 2100. In such embodiments, the perch 2100 may be flexible enough and/or loosely mounted enough to allow the bird to deflect the perch 2100 sufficient to ring the bell 2101. The toy bell 2101 may be any style of bell. The bell 2101 may be suspended from a rope or chain or any suitable means including an elastic strap that can stretch in response to the pet bird pulling on the toy. In some embodiments, other toys, including any number of different shapes and interactive electronic/mechanical devices, may be suspended from the perch 2100. For example, a pull string device that plays a recording of the pet owner's voice may be suspended from the perch 2100.

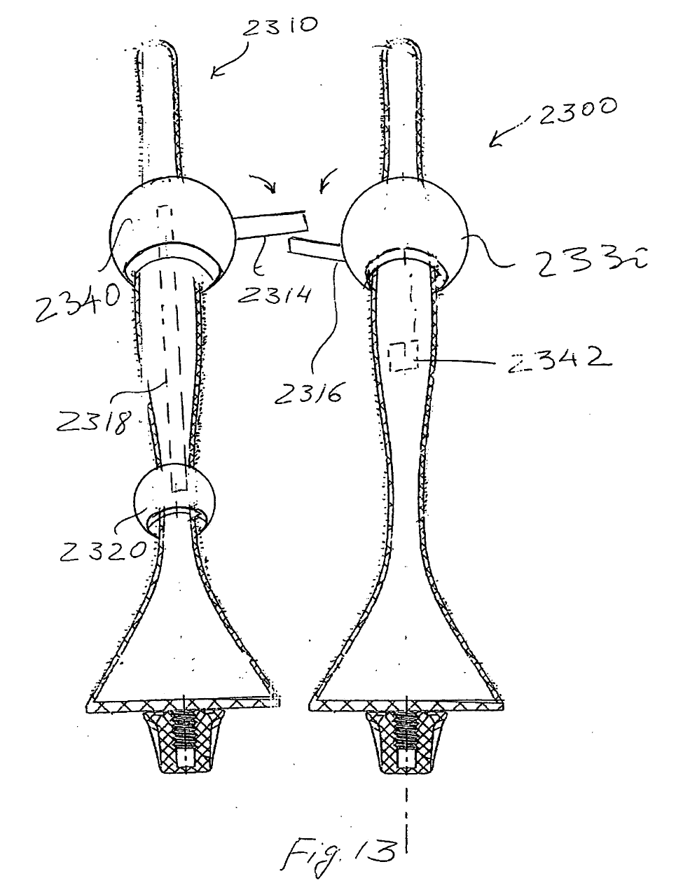

Turning to FIG. 13, a kit may include at least two perches 2300 and 2310, respectively, rotatably mounted to the bird cage as disclosed above in a spaced relationship. The perches have a plurality of toys mounted on respective perches 2300 and 2310 so that adjacent toys 2330 and 2340 are aligned. Projections 2316 and 2314, which are formed on respective toys 2330 and 2340 overlap one another so that when either of the toys is altered by a pet bird, its projection will engage the adjacent projection and, thus, actuate the other toy. At least one of perches 2300 and 2310 is provided with an inner axle 2318 coupling for example, toy 2340 to another toy 2320, which is rotatably mounted on the same perch, so that when either of toys 2340 and 2320 is altered by the pet bird, both toys synchronously rotate. As mentioned above, actuation of a toy may be accompanied by an audible signal. For example, an electromechanical sound generating unit 2342 may be mounted within perch 2300 and coupled to toy 2330 so as to produce the signal once the toy is actuated, as diagrammatically illustrated by a dot line between the toy and the unit.

This document describes inventive bird perches with integrated interactive toys for illustration purposes only. Neither the specific embodiments of the invention as a whole, nor those of its features limit the general principles underlying the invention. In particular, the invention is not limited to any specific configuration of openings, shapes, texturing, and attachment/mounting configuration. For example, and interactive bird perch according to the present invention may include any combination of any of the interactive toys 1001, 1101, 1201, 1301/1302, 1401/1402, 1501/1502, 1601/1602, 1701, 1801, 1901, 2001, 2101 described above. In such embodiments, different toys may be replaceable and/or substitutable for each other such that the perch is configurable by the pet caretaker (e.g., pet owner). The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention. The invention is to be construed with reference to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A bird perch unit, comprising:
a body coupleable to a bird cage and having an outer surface grippeable by a bird; and
an interactive toy coupled to the body and alterable by the bird.

2. The unit of claim 1, wherein the toy is mounted to the body so as to selectively rotate in opposite directions about a longitudinal axis of the toy upon being altered by the bird.

3. The unit of claim 2, further comprising a rotatable component selected from the group consisting of a collar and bearing, the rotatable component being rotatably mounted on the outer surface and rotationally fixed to an inner surface of the toy.

4. The unit of claim 2, wherein the toy has a shape selected from the group consisting of a double headed arrow, polygonal, bird profile, irregular, elliptical, and round shape.

5. The unit of claim 4, wherein the toy has a hole configured to be traversed by the gripping surface.

6. The unit of claim 5, wherein the body having the double-arrowed shape is configured with two arrow-shaped components having respective bases coupled to one another, the arrow-shaped components being uniformly configured or non-uniformly configured.

7. The unit of claim 3, wherein the toy is selected from the group consisting of a wheel, bristles, nut, pilot's ship wheel, and spinning tire and a combination thereof.

8. The unit of claim 2, further comprising at least one additional toy mounted to the body, the toys being rotatable independently from one another or rotatably fixed to one another.

9. The unit of claim 1, further comprising a toy support mounted to the body and configured to support the toy so that the bird stretches in order to alter the toy.

10. The unit of claim 9, wherein the toy support includes an armature having one end coupled to the outer surface of the body and a free end spaced therefrom, the toy being suspended on the free end of the armature and configured to swing relative thereto upon being altered by the bird.

11. The unit of claim 10, further comprising a flexible component selected from the group consisting of a rope, chain and elastic strap, the flexible element having opposite ends coupled to the free end of the armature and the toy, respectively.

12. The init of claim 9, wherein the toy support is configured as a flexible component suspended on the outer gripping surface so as to form a loop, the toy being coupled to the flexible component so that the loop moves relative to the body upon altering the toy by the bird.

13. The unit of claim 9, wherein the body has a through going hole, the support being selected from the group consisting of a rod, linked rod, rope, elastic stretchable strap and chain and configured to slide through the hole relative to the body upon altering the toy by the bird.

14. The unit of claim 9, wherein the toy is configured to generate a sound upon altering the toy by the bird.

15. The unit of claim 14, wherein the toy is selected from the group consisting of a bell and a sound generated device, the sound generated device being selected from the group consisting of a mechanical device and electrical device and a combination thereof operative to generate a sound upon altering the toy by the bird.

16. The unit of claim 1, wherein the toy is removably coupled to the body, the body being configured as a one-piece, hollow, injection-molded structure, the toy being configured so that a bird cage operator is capable of locating the toy at any point on the body.

17. The unit of claim 1, further comprising a coupling unit configured to detachably couple the body to the bird cage, the coupling component having a threaded fastener on one end of the body and a nut threadedly engaging the threaded fastener.

18. A kit comprising a perch unit, the perch unit being configured with:
at least one body coupleable to a bird cage and having an outer surface grippeable by a bird; and
a plurality of toys each coupleable to the gripping surface and alterable by the bird.

19. The kit of claim 18, wherein the perch unit comprises at least one additional body coupleable to bird cage at a distance from the at least one body so that the toys on the one and additional bodies selectively interact with one another upon altering at least one of the toys by the bird.

20. The kit of claim 19, wherein at least some of the toys on the one and additional bodies each are rotatable upon being altered by the bird, the rotatable toys being mounted to the one and additional bodies so that at least two of the rotatable toys on the respective one and additional bodies are aligned with and actuate one another when the bird alters either of the aligned toys.

21. The kit of claim 18, wherein the toys on the body are coupled to one another so as to be synchronously altered together in response to actuating at least one of one of the toys by the bird.

22. The kit of claim 18, further comprising an electromechanical unit mounted within the body or outside the body within the bird cage, the electromechanical unit being coupled to at east one of the toys and operable to generate an audible signal in response to altering the at least one toy by the bird.

23. The kit of claim 20, wherein the toys are uniformly shaped and dimensioned or nonuniformly shaped and dimensioned, at least some of the toys being operable to be removably mounted to the body.

24. The kit of claim 19, wherein the one and additional bodies are uniformly configured or nonuniformly configured and each formed as a one-piece, hollow, injection-molded structure.

25. The kit of claim 18, at least some of the plurality of toys are displaceable relative to the body upon being altered by the bird.
